(19) United States
(12) Patent Application Publication
(10) Pub. No.: US 2008/0061112 A1
(43) Pub. Date: Mar. 13, 2008

(54) Method for soldering charge coupled device and tooling thereof

(76) Inventors: Shih-Ju Liang, Hsinchu (TW); Wen-Ming Lai, Hsinchu (TW); Chih-Hung Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/516,477

(22) Filed: Sep. 7, 2006

(51) Int. Cl. A47J 36/02

(52) U.S. Cl. 228/101

(57) ABSTRACT

A method for soldering charge coupled device to improve the yield, working efficiency and imperfection of manual soldering. The method includes the steps of heating a base of a tooling by a heating board; putting a circuit broad having solders on the base; melting the solders on the circuit board by the heat conducted from the base; aligning the pins of the charge coupled device to the solders and applying a pressing force to assure a proper contact between the pins and the solders; and removing the tooling from the heating board for cooling.

### BACKGROUND OF THE INVENTION

1. Field of the invention

The present invention relates to a soldering method, and more particularly to a method for soldering a charge coupled device and tooling thereof.

2. Description of Related Art

Soldering technologies are introduced and developed substantially for the application of metals, and increasingly more soldering technologies are applied in different technical fields particularly at the present time of rapid electronic and industrial advancements.

Referring to FIG. 1 for a schematic view of soldering electronic components on a charge coupled device, the surface of an optical sensor on the charge coupled device (CCD) 60 has a capability of storing electric charges, such that when the optical sensor detects any light on the surface of the charge coupled device 60, the electric charges will act on the sensor, and all signals produced by the optical sensor of the charge coupled device 60 will define a complete screen. Thus, the charge coupled device 60 is usually used as an optical sensor in an image capturing device.

In general, the charge coupled device 60 is soldered at an application circuit board 62 first before it can be used. However, the existing technology uses a clamping tool 61 as a fixture, and then uses a soldering iron 63 to solder the charge coupled device 60. In FIG. 1, pins 601 of the charge coupled device 60 are arranged in high density, and thus it is relatively difficult to solder the pins 601 to solder joints 602 on the circuit board 62 by the soldering iron 63 manually. Furthermore, the heat resistance of electronic components is low, such that if the temperature of the soldering iron 63 is too high or the soldering iron 63 stays on the solder joints 602 and pins 601 too long, then the charge coupled device 60 will be damaged. Furthermore, solder beadings will be formed easily in a manual soldering process, and such solder beadings are defects that will result short circuits and ruin the appearance of the device.

If the soldering iron 63 is used to solder the charge coupled device 60 manually, the yield will be lower, and the operation will become more difficult and cause a less satisfactory working efficiency. Therefore, the traditional way of soldering a charge coupled device 60 definitely requires improvements.

### SUMMARY OF THE INVENTION

In view of the foregoing shortcomings, the present invention provides a method for soldering a charge coupled device to overcome the foregoing problems of the traditional manual soldering and improve the yield and working efficiency. The method includes the steps of preheating a heating board; preheating a tooling by putting the tooling on the heating board; putting a circuit broad having solders on a base for the preheating to melt the solders; putting the charge coupled device on the circuit board having solders; contacting the pins of the charge coupled device properly with the solders of the circuit board; and removing the tooling from the heating board for cooling.

The present invention further provides a tooling for soldering a charge coupled device, wherein a fixed substrate and a circuit board having solders are placed on the tooling, and the charge coupled device is soldered onto the fixed substrate. The tooling comprises a base and a pressing apparatus. The base is provided for contacting a heating board, and the base has a plane, and a plurality of fixing pivots on the plane. The fixing pivots are used for fixing the circuit board having solders and a fixed substrate, such that pins on the charge coupled device are aligned with solders on the circuit board having solders. The pressing apparatus is installed at the top of the base for exerting a pressure on the charge coupled device, so that the pins on the charge coupled device can be contacted properly with the solders on the circuit board having solders.

To make it easier for our examiner to understand the innovative features and technical content of the invention, we use a preferred embodiment together with the attached drawings for the detailed description of the invention, but it should be pointed out that the attached drawings are provided for reference and description but not for limiting the present invention.

### BRIEF DESCRIPTION OF THE DRAWINGS

FIG. 1 is a schematic view of soldering electronic components on a charge coupled device according to a prior art;

FIG. 2 is a schematic view of a tooling for soldering a charge coupled device in accordance with a preferred embodiment of the present invention;

FIG. 3 is a schematic view of the connection between a charge coupled device and a circuit board in accordance with a preferred embodiment of the present invention;

FIG. 4 is a schematic view of soldering a charge coupled device in accordance with a preferred embodiment of the present invention; and

FIG. 5 is a flow chart of soldering a charge coupled device in accordance with a preferred embodiment of the present invention.

### DETAILED DESCRIPTION OF THE PREFERRED EMBODIMENTS

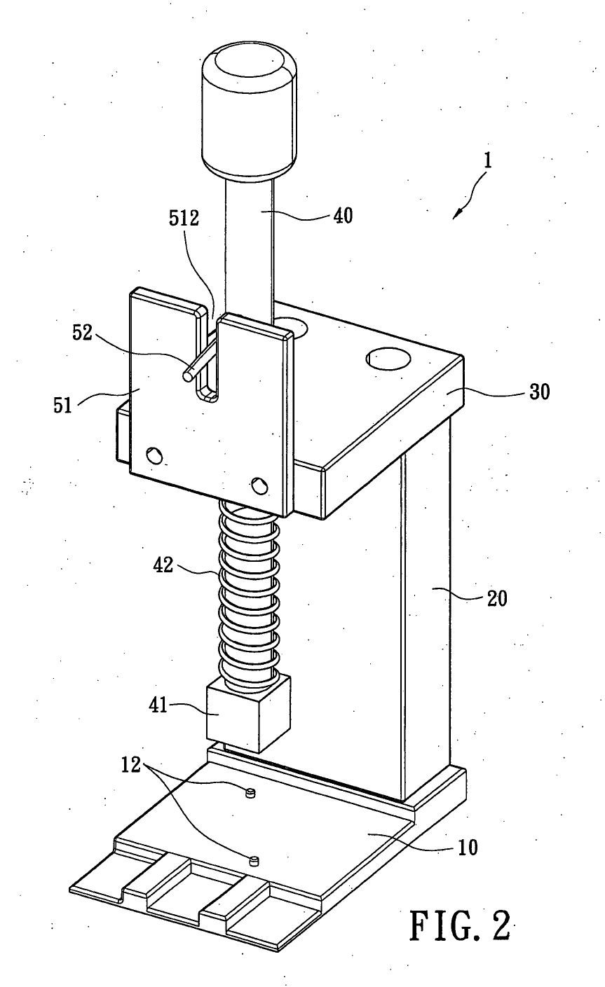

Referring to FIG. 2 for a schematic view of a tooling for soldering a charge coupled device in accordance with a preferred embodiment of the present invention, the tooling 1 comprises a base 10 and a pressing apparatus.

The base 10 includes a plurality of fixing pivots 12 disposed on a plane of the base 10 for fixing the base 10 between a circuit board and a charge coupled device, such that the pins of the charge coupled device are aligned to the solders on the circuit board, and the connection between the circuit board and the charge coupled device will be described later. The base 10 is made of a metal which is preferably a aluminum-aluminum alloy used for conducting heat, when the charge coupled device is soldered.

The pressing apparatus includes a support portion 20, a platform 30, a pressing rod 40, a pressing block 41, a resilient element 42, a pressing limit portion 51, a protruding rod 52 and a slot 512, for providing a pressing force. The support portion 20 is disposed between the platform 30 and the base 10, for supporting the platform 30. The pressing rod 40 is passed through the platform 30, and the bottom of the platform 30 has a pressing block 41. The pressing rod 40 between the pressing block 41 and the platform 30 has a resilient element 42 thereon. The pressing rod 40 above the platform 30 has a protruding rod 52. The platform 30 has a pressing limit portion 51 disposed on a side of the platform 30, and the pressing limit portion 51 has a slot 512. An end of the protruding rod 52 is connected to the pressing rod 40, and the body of the protruding rod 51 can be moved vertically up and down based on the pressing movement of the pressing rod 40.

If a force is applied to the pressing rod 40 to latch the protruding rod 52 to the bottom of the slot 512, a pressing force will be exerted onto an object pressed by the pressing block 41. The foregoing pressing apparatus is an embodiment providing a pressing force to a soldering charge coupled device.

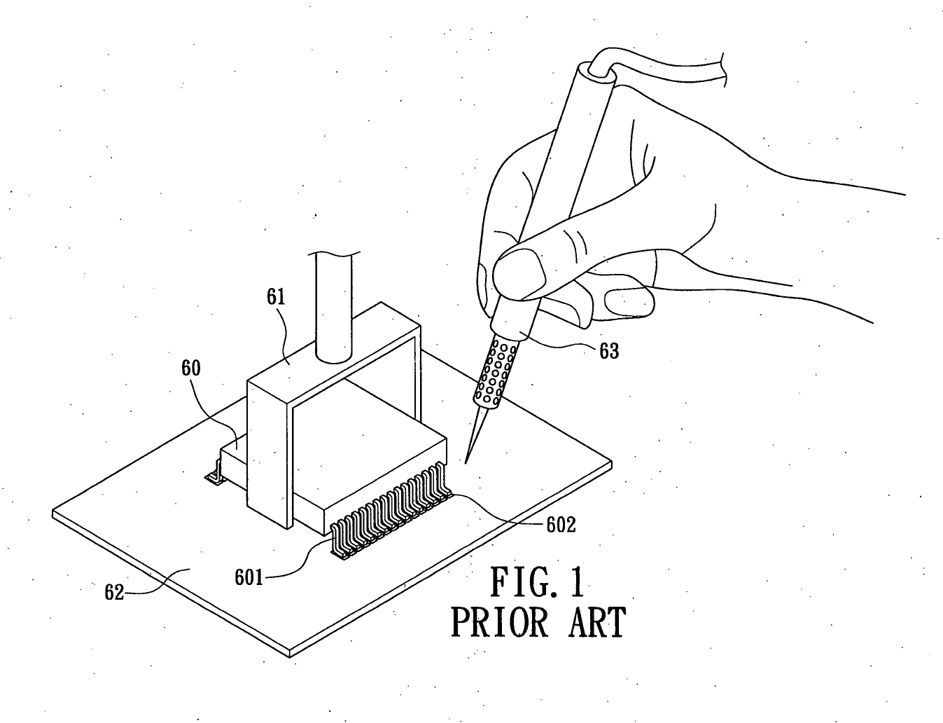

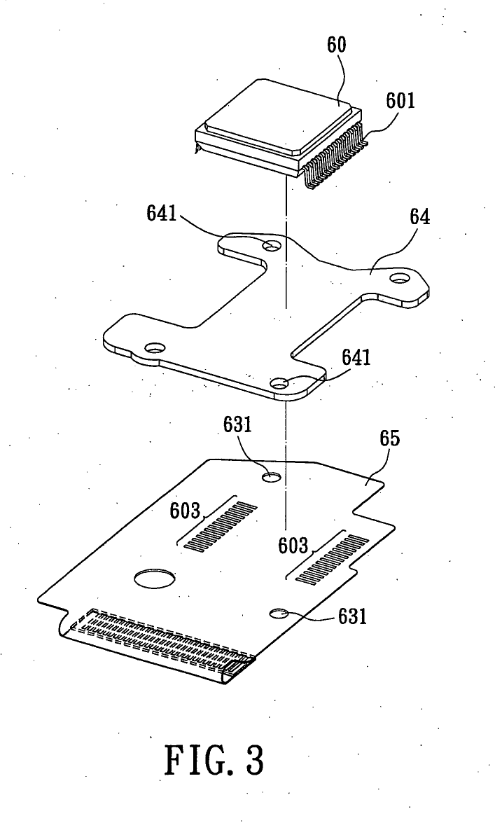

Referring to FIG. 3 for a schematic view of the connection between a charge coupled device 60 and a circuit board 65 in accordance with a preferred embodiment of the present invention, it shows a charge coupled device 60, a fixed substrate 64 and a circuit board having solders 65. The charge coupled device 60 is adhered onto the fixed substrate 64 by a gluing method. The fixed substrate 64 is made of a metal and has two fixing holes 641, and the circuit board having solders 65 also has two fixing holes 631. In FIG. 1, two fixing pivots 12 pass through the two fixing holes 631 on the circuit board having solders 65 and the two fixing holes 641 on the fixed substrate 64 to connect the fixed substrate 64 and the circuit board having solders 65, such that a pin 601 of the charge coupled device 60 is aligned with a solder joint 603 of the circuit board having solders 65 having solders.

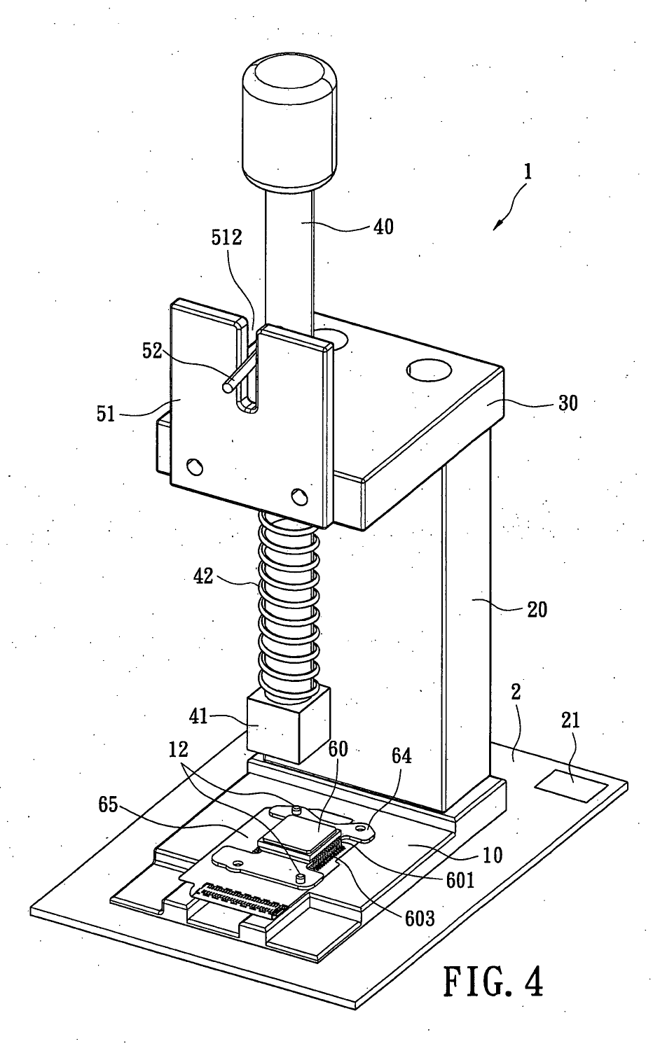

Referring to FIG. 4 for a schematic view of soldering a charge coupled device in accordance with a preferred embodiment of the present invention, the principle of using a tooling of the invention to solder a charge coupled device will be described as follows. Firstly, a heating board 2 is preheated. The heating board 2 includes a temperature display unit 21, for displaying a temperature on the heating board 2. If the heating board 2 is preheated to a desired temperature (approximately 260° C.), then a tooling 1 is put on the heating board 2, so that a base 10 of the tooling 1 can be preheated to the desired temperature. Then, a circuit board having solders 65 is put on a plane of the base 10, so that the heat on the base 10 can gradually melt the solders on the circuit board having solders 65. Then, the fixed substrate 64 with the charge coupled device 60 are put on the circuit board having solders 65, and the fixed substrate 64 and the circuit board having solders 65 are fixed by the fixing pivots 12, while the pin 601 of the charge coupled device 60 is aligned with the solder of the solder joint 603 of the circuit board having solders 65. The pressing apparatus is used to apply a pressing force to the charge coupled device 60, so that the pin 601 of the charge coupled device 60 is secured to the solder of the circuit board having solders 65. If a force is applied to latch the protruding rod 52 to the bottom of the slot 512, a pressing force will be exerted onto the charge coupled device 60 to assure a proper contact between the pin 601 and the solder on the solder joint 603. Finally, the tooling 1 is removed from the heating board 2 for cooling. A fan can be used for cooling the tooling 1. Since the fixed substrate 64 is made of a metal, the metal can assist dissipating the heat. After the tooling 1 is cooled, the soldered circuit board of the charge coupled device 60 can be removed from the tooling 1.

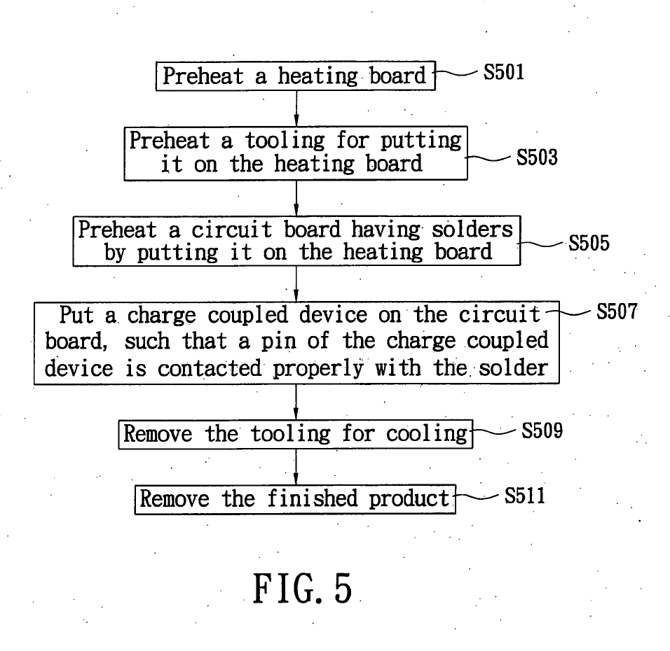

Referring to FIG. 5 for a flow chart of soldering a charge coupled device in accordance with a preferred embodiment of the present invention, the soldering process comprises the steps of: preheating a heating board 2 to approximately 260° C. (as shown in S501); preheating a tooling 1 by putting the tooling 1 on the heating board 2, such that a base 10 can be heated to a desired temperature (as shown in S503); putting a circuit board having solders 65 on the base 10, such that the heat on the base 10 melts the solder of a solder joint 603 on the circuit board having solders 65 (as shown in S505); putting a charge coupled device 60 on the circuit board having solders 65, and using a pressing apparatus to contact a pin of the charge coupled device 60 with a solder of the circuit board 65 (as shown in S507), wherein the pin 601 of the charge coupled device 60 can be aligned with the solder of the solder joint 603 on the circuit board having solders 65 by the fixing between the fixed substrate 64 and the circuit board having solders 65; removing the tooling 1 from the heating board 2 for cooling, after the pin 601 is contacted properly with the solder (as shown in S509); and finally removing the soldered circuit board of the charge coupled device 60 from the tooling 1 (as shown in S511).

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method for soldering charge coupled device, comprising the steps of:
preheating a heating board;
preheating a tooling by putting said tooling on said heating board;
preheating a circuit board having solders by putting said circuit board on said tooling;
fixing a charge coupled device onto said circuit board having solders, and contacting pins of said charge coupled device with a solder on said circuit board having solders; and
removing said tooling from said heating board for cooling.

2. The method of claim 1, wherein said step of preheating said circuit board having solders by putting said circuit board having solders on said tooling further preheats said circuit board having solders until said solders on said circuit board having solders are melted, and then puts said charge coupled device on said circuit board having solders.

3. The method of claim 1, further comprising a step of putting said charge coupled device on a fixed substrate, and then aligning pins on said charge coupled device with a solder on said circuit board having solders by fixing said fixed substrate with said circuit board having solders.

4. The method of claim 3, wherein said circuit board having solders is put on said tooling and fixed to said fixed substrate by a plurality of fixing pivots on said tooling.

5. The method of claim 3, wherein said charge coupled device is adhered on said fixed substrate by a gluing method.

6. The method of claim 3, wherein said fixed substrate is made of a metal for assisting heat dissipation and cooling when said tooling is removed.

7. The method of claim 1, further comprising a step of using a fan to cool said tooling when said tooling is removed from said heating board.

8. The method of claim 1, further comprising a step of using a pressing apparatus to apply a pressure to said charge coupled device, such that said pins of said charge coupled device are contacted properly with said solders of said circuit board having solders.

9. A tooling for soldering charge coupled device, that puts a fixed substrate and a circuit board having solders on said tooling, for soldering a charge coupled device installed on said fixed substrate, and said tooling comprising:
a base, for contacting a heating board, and having a plane, and a plurality of fixing pivots disposed on said plane for fixing said circuit board having solders with said fixed substrate, such that said pins on said charge coupled device are aligned with said solders on said circuit board having solders; and
a pressing apparatus, disposed at the top of said base, for providing a pressure to said charge coupled device, such that said pins on said charge coupled device are contacted properly with said solders of said circuit board having solders.

10. The tooling of claim 9, wherein said base is made of a metal, for conducting the heat to said circuit board having solders.

11. The tooling of claim 10, wherein said metal base is a made of an aluminum alloy.

12. The tooling of claim 9, wherein said heating board includes a temperature display unit, for displaying the heating temperature.

13. The tooling of claim 9, wherein said pressing apparatus comprises:
a platform;
a support portion, disposed between said base and said platform;
a pressing rod, passed through said platform and aligned with said charge coupled device;
a pressing block, disposed at a lower end of said pressing rod, for contacting said charge coupled device;
a resilient element, installed between said platform and said pressing block and disposed on said pressing rod;
a protruding rod, with an end coupled to said pressing rod; and
a pressing limit portion, disposed on a side of said platform, and having a slot, for limiting the movements of said protruding rod;
whereby if a force is applied to said pressing rod to latch said protruding rod at the bottom of said slot, said pressing block will exert a pressing force onto said charge coupled device, for contacting said pins on said charge coupled device with said solders on said circuit board having solders.
